(19) United States
(12) Patent Application Publication
(10) Pub. No.: US 2008/0211319 A1
(43) Pub. Date: Sep. 4, 2008

(54) Systems and methods for electrical power supply

(75) Inventors: Cory R. Williamson, Bozeman, MT (US); Martin Albini, Bozeman, MT (US); Thomas J. Wernikowski, Bozeman, MT (US); Mark Gentzen, Bellevue, WA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(73) Assignee: VOLTAP, LLC, Bellevue, WA (US)

(21) Appl. No.: 12/001,075

(22) Filed: Dec. 7, 2007

Related U.S. Application Data
(60) Provisional application No. 60/873,952, filed on Dec. 11, 2006.

(51) Int. Cl. H01B 7/30

(52) U.S. Cl. 307/147

(57) ABSTRACT

The present invention relates to systems and methods for providing an electrical power supply system that may be used in various environments including those that are prone to liquid spills, debris buildup, and accidental contact (by a human or animal such as a pet) and those environments with curves that require a flexible power supply system.

### CROSS REFERENCE TO RELATED APPLICATIONS

This application claims priority to and the benefit of U.S. provisional patent application No. 60/873,952, filed on Dec. 11, 2006, the entire disclosure of which is incorporated by reference herein.

### FIELD OF THE INVENTION

The present invention relates to providing electrical power. More particularly, the present invention relates to providing electrical power in an environment where accidental contact, liquid spills, and/or debris buildup may occur.

### BACKGROUND OF THE INVENTION

Track power supply systems are well known, and are traditionally used, along with one or more lamps, to provide a simple, cost-effective, and attractive interior lighting solution. Such systems normally consist of a pair of wires running through the space being lit, and are traditionally hung from a ceiling or high upon a wall.

While these existing power supply systems do fulfill certain purposes, they are inappropriate for use in more accessible environments due, in part, to the unprotected nature of the power-providing wires. For instance, the use of presently available systems at or near a level where people and pets regularly interact with the environment creates an inherent risk of shock. Use in an environment where liquids might spill is also inappropriate as such spills would cause the wires to short. Likewise, dirt or other debris contacting the wires in a highly trafficked area could decrease the wires' conductivity. Presently-used systems are also inherently difficult to clean, as each wire must be cleaned independently and carefully to avoid risk of shock. Due to these drawbacks, existing track power supply systems are normally used in areas (near ceilings and high on walls) where there is little possibility of accidental contact (by a human or animal such as a pet), liquid spills, and/or debris buildup. Traditional track power supply systems are also difficult to mount, often requiring professional installation. Thus, there is room for improvement in the design of track power supply systems to make these systems more appropriate for use in a broader range of environments and contexts while still minimizing the occurrence of adverse events related to their use.

### SUMMARY OF THE INVENTION

The present invention addresses the previously described drawbacks of currently used track power supply systems by providing systems and methods that allow for the use of such systems in a broader range of environments and contexts. The systems and methods of the present invention allow for such broader use by providing electrical power supply systems that lessen the risk of inadvertent shock, shorts due to liquid in the environment, and/or decreased conductivity due to dirt or other materials found in highly trafficked areas. The systems and methods of the present invention are also easily cleaned without risk of shock or shorts. The present invention provides these benefits by providing electrical power supply systems with two conductive materials, a protective layer and a support layer that, due to its shape, allows necessary access to the conductive materials.

Specifically, one embodiment according to the present invention includes an electrical power supply system comprising a non-conductive protective layer comprising a top surface and a bottom surface; a non-conductive support layer comprising a top surface and a bottom surface; a first conductive material; and a second conductive material, wherein the first conductive material and the second conductive material are located between the top surface of the protective layer and the bottom surface of the support layer.

In another embodiment according to the present invention, the non conductive support layer is shaped to allow access to the first conductive material and the second conductive material.

In another embodiment according to the present invention, the bottom surface of the support layer can be adhesive or associated with an adhesive.

Electrical power supply systems according to the present invention can also comprise one or more connector devices, the connector devices comprising a first conductive contact; and a second conductive contact, wherein the first conductive contact can engage the first conductive material, the second conductive contact can engage the second conductive material; and wherein when engaged to the first and second conductive materials, the connector device provides a conduit for electrical power to travel from the electrical power supply to an electrical device.

In certain embodiments according to the present invention, one or more of the one or more connector devices can further comprise an over-current protection circuit. The over-current protection circuit(s) monitor the current voltage draw through their respective connector device(s) and can terminate operation of the connector device if the voltage draw exceeds a preset voltage level. In another embodiment, the over-current protection circuit(s) are automatically resetting.

Particular embodiments according to the present invention can include electrical power supply systems as variously described herein operating using about 50 volts or less.

In one embodiment according to the present invention, the non-conductive protective layer, the first conductive material, and the second conductive material are created as a co-extrusion. In another embodiment according to the present invention, one or more of the protective layer, the first conductive material, the second conductive material, and the support layer are flexible.

Protective layers and/or support layers used in accordance with the present invention can comprise a non-conductive material selected from the group consisting of, without limitation, rubber, polyethylene, polyvinyl chloride, impregnated paper, neoprene, plastic, foam, glass, porcelain, composite, and combinations thereof.

First and/or second conductive materials used in accordance with the present invention can comprise a conductive material selected from the group consisting of, without limitation, copper, silver, aluminum, steel, gold, tin, lead, nickel, graphite, and combinations thereof.

Electrical power systems according to the present invention can be mounted to a surface and/or used to power one or more point of purchase displays. Appropriate electrical devices to be powered with the systems and methods of the present invention include, without limitation (and whether they are a point of purchase display or not) beer tap handles, lighted signs, noise generators, moving ornamentations, video monitors, computers, clocks, lamps, radios, speaker systems, smoke generators, fountains, wireless devices and circuits, etc.

Another embodiment according to the present invention includes an over current protection circuit for use with an electrical power supply system of the present invention.

One particular embodiment according to the present invention includes an electrical power supply system comprising a non-conductive protective layer comprising a top surface and a bottom surface; a non-conductive support layer comprising a top surface and a bottom surface; a first conductive material; and a second conductive material, wherein the first conductive material and the second conductive material are located between the top surface of the protective layer and the bottom surface of the support layer; wherein the non-conductive support layer is shaped to allow access to the first conductive material and the second conductive material; wherein the bottom surface of the support layer is adhesive or is associated with an adhesive; and wherein one or more of the protective layer, the first conductive material, the second conductive material, and the support layer are flexible. In another embodiment, the particularly described embodiment can operate using a voltage of about 50 volts or less and can be used to power an electrical device in a point of purchase display.

The present invention also includes methods. One method of providing power according to the present invention comprises providing a non-conductive protective layer comprising a top surface and a bottom surface; providing a non-conductive support layer comprising a top surface and a bottom surface; providing a first conductive material; and providing a second conductive material, wherein the first conductive material and the second conductive material are located between the top surface of the protective layer and the bottom surface of the support layer and wherein the non-conductive support layer is shaped to allow access to the first conductive material and the second conductive material and wherein the electrical power system further comprises one or more connector devices, the connector device comprising a first conductive contact; and a second conductive contact, wherein the first conductive contact is designed to engage the first conductive material, the second conductive contact is designed to engage the second conductive material; and wherein, when engaged to the first and second conductive materials, the connector device provides a conduit for electrical power to travel from the electrical power supply to an electrical device.

In another method according the present invention, the support layer is adhesive or is associated with an adhesive for mounting onto a surface.

In another method according to the present invention, one or more of the protective layer, the first conductive material, the second conductive material, and the support layer are flexible.

The present invention also includes connector devices. In one embodiment the present invention includes a connector device for use with an electrical power supply system wherein the electrical power system comprises a non-conductive protective layer comprising a top surface and a bottom surface; a non-conductive support layer comprising a top surface and a bottom surface; a first conductive material; and a second conductive material, wherein the first conductive material and the second conductive material are located between the top surface of the protective layer and the bottom surface of the support layer and wherein the connector device comprises a first conductive contact; and a second conductive contact, wherein when engaged to the first and second conductive materials the first conductive contact can engage the first conductive material, the second conductive contact can engage the second conductive material; and wherein the connector device provides a conduit for electrical power to travel from the electrical power supply to an electrical device. In another embodiment the connector device can comprise an over-current protection circuit. In another embodiment the over-current protection circuit monitors the current voltage draw through the connector device and may terminate operation of the connector device if the voltage draw of the connector device exceeds a preset voltage level. In another embodiment the over-current protection circuit is automatically resetting.

### BRIEF DESCRIPTION OF THE DRAWINGS

FIG. 1 is a cross-sectional diagram of one specific embodiment of an electrical power supply system of the present invention.

FIG. 2 is a perspective view of one specific embodiment of an electrical power supply system of the present invention.

FIG. 3 is a cross-sectional diagram of one specific embodiment of an electrical power supply system of the present invention.

### DETAILED DESCRIPTION

Existing track power supply systems are inappropriate for use in more accessible environments such as, without limitation, bars and supermarkets due, in part, to the unprotected nature of the power-providing wires. These unprotected wires create an inherent risk of shock, short, and decreases in conductivity due to the presence and/or build up of dirt or other debris. Presently-used systems are also inherently difficult to clean. Due to these drawbacks, existing track power supply systems are normally used in areas (near ceilings and high on walls) where there is little possibility of accidental contact (by a human or animal such as a pet), liquid spills, and/or debris buildup.

The present invention addresses the drawbacks of the existing systems by providing for an electrical power supply that comprises a protective layer which may prevent accidental contact, liquid spills, and/or debris buildup from impairing the functionality of the power supply or causing damage to the environment surrounding the power supply. The present invention, by providing, in specific embodiments, an adhesive layer, also addresses another drawback of traditional track power supply systems: difficult installation.

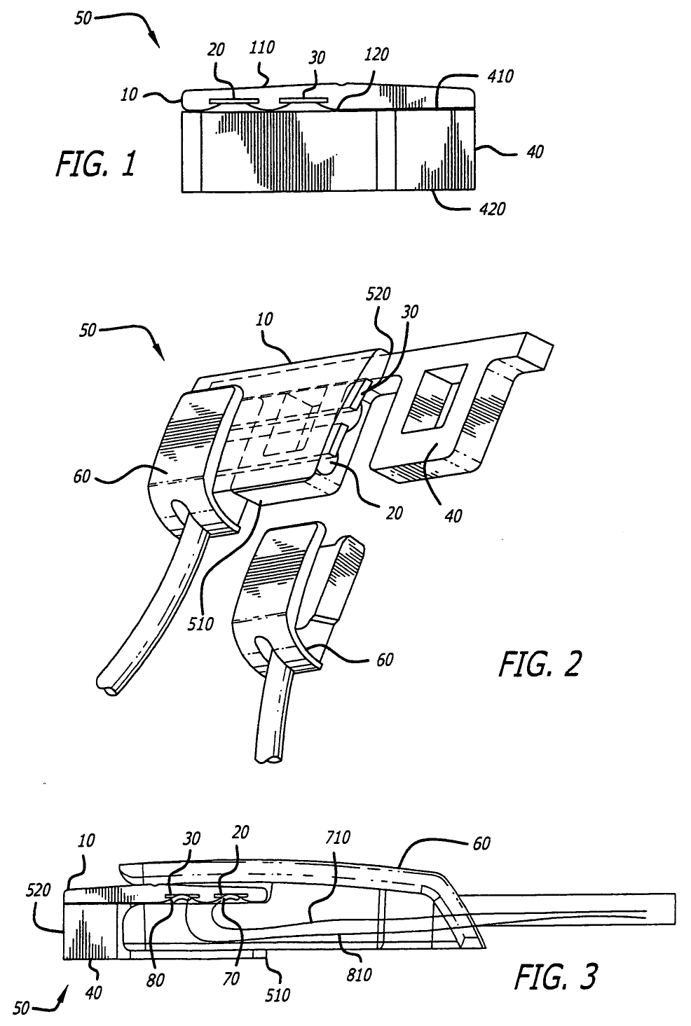

FIG. 1 illustrates a cross-section view of one specific embodiment of an electrical power supply system of the present invention. As shown in FIG. 1, electrical power supply system 50 may comprise a first conductive material 20. First conductive material 20 may comprise any conductive material as understood by one of ordinary skill in the art, and may specifically comprise any appropriate metal such as, without limitation, copper, silver, aluminum, steel, gold, tin, lead, nickel, or an alloy; any appropriate non-metallic conductor such as, without limitation, graphite; or any combination thereof. As shown, first conductive material 20 may comprise a flat strip. Alternatively, first conductive material 20 may comprise a round wire or any other appropriate shape. In specific embodiments, first conductive material 20 may comprise a flexible or semi-flexible material. Alternatively, first conductive material 20 may comprise a rigid or semi-rigid material. In one specific embodiment, first conductive material 20 may be about one sixteenth inch thick, although this dimension is not required and is provided for exemplary purposes only.

Electrical power supply system 50 may also comprise a second conductive material 30. Second conductive material 30 may comprise any conductive material as understood by one of ordinary skill in the art, and may specifically comprise any appropriate metal such as, without limitation, copper, silver, aluminum, steel, gold, tin, lead, nickel, or an alloy; any appropriate non-metallic conductor such as, without limitation, graphite; or any combination thereof. As shown, second conductive material 30 may comprise a flat strip. Alternatively, second conductive material 30 may comprise a round wire or any other appropriate shape. In specific embodiments, second conductive material 30 may comprise a flexible or semi-flexible material. Alternatively, second conductive material 30 may comprise a rigid or semi-rigid material. In one specific embodiment, second conductive material 30 may be about one sixteenth inch thick, although this dimension is not required and is provided for exemplary purposes only.

In a specific embodiment, first conductive material 20 may act as a powered lead and second conductive material 30 may act as a neutral lead. Alternatively, first conductive material 20 may act as a neutral lead and second conductive material 30 may act as a powered lead. In either embodiment, the powered lead may have, without limitation, below about 50 volts on it and the neutral lead may have about 0 volts on it. As will be understood by one of ordinary skill in the art, however, depending on the intended use for a particular electrical power supply system, various other voltages can be used in accordance with the systems and methods of the present invention.

In addition to a first and second conductive material 20, 30, embodiments according to the present invention also comprise a protective layer 10. As shown, protective layer 10 may comprise a top surface 110 and a bottom surface 120. Protective layer 10 may comprise any non-conductive material as understood by one of ordinary skill in the art, and may specifically comprise, without limitation, rubber, polyethylene, polyvinyl chloride, impregnated paper, neoprene, plastic, foam, glass, porcelain, composite, or any combination thereof.

In specific embodiments, protective layer 10 may comprise a flexible or semi-flexible material. Alternatively, protective layer 10 may comprise a rigid or semi-rigid material. As shown in FIG. 1, in certain embodiments, top surface 110 of protective layer 10 may comprise a slightly convex surface. A convex surface can allow liquids to easily run off of top surface 110 and can make top surface 110 easy to clean. Alternatively, top surface 110 of protective layer 10 may comprise some other functional or aesthetically pleasing shape. In specific embodiments, protective layer 10 may be about one quarter inch thick, although this dimension is not required and is provided for exemplary purposes only.

In certain embodiments according to the present invention, protective layer 10 acts as a barrier to prevent access to first and second conductive material 20, 30 from one side (in one embodiment the top side) of electrical power supply system 50. In specific embodiments, protective layer 10 may also act to keep first conductive material 20 from coming into contact with second conductive material 30. In other specific embodiments, protective layer 10, first conductive material 20, and second conductive material 30 may be created together as a co-extrusion. Because protective layer 10, in specific embodiments, acts as a barrier between the conductive materials 20, 30 and accidental contact, liquid spills, and/or debris buildup, it also blocks access to conductive materials 20, 30 that is necessary to utilize the electrical power supply system 50. As such, a novel way to connect to the conductive materials 20, 30 is needed, and is provided for below.

In addition to first and second conductive material 20, 30 and protective layer 10, systems and methods according to the present invention also comprise a support layer 40. As shown in FIG. 1, support layer 40 may comprise a top surface 410 and a bottom surface 420. As can be seen more clearly in FIG. 2, support layer 40 is shaped in such a manner to allow access to first conductive material 20 and second conductive material 30. In the embodiment depicted in FIG. 2, protective layer 10, first conductive material 20, second conductive material 30, and support layer 40 extend together in parallel fashion, and the electrical power supply system 50 has a proximal surface 510 and a distal surface 520. In this depicted embodiment, protective layer 10 and support layer 40 are joined along the entirety of distal surface 520. To allow access to conductive materials 20, 30, support layer 40 extends from distal surface 520 to proximal surface 510 intermittingly.

Support layer 40 may comprise any non-conductive material as understood by one of ordinary skill in the art, and may specifically comprise, without limitation, rubber, polyethylene, polyvinyl chloride, impregnated paper, neoprene, plastic, foam, glass, porcelain, composite, or any combination thereof. In specific embodiments, support layer 40 may comprise a flexible or semi-flexible material. Alternatively, support layer 40 may comprise a rigid or semi-rigid material. In specific embodiments, support layer 40 may be about one quarter inch thick, although this dimension is not required and is provided for exemplary purposes only. Thus, the systems and methods according to the present invention provide an electrical power supply system that can be used in highly trafficked areas without the risk of inadvertent shock, shorts due to liquid spills or other contact and conductivity decreases due to the presence of dirt and/or other debris build up. Non-limiting examples of such highly trafficked areas include in bars, such as, without limitation on beer towers, and in supermarkets, such as, without limitation, on shelves.

In certain embodiments according to the present invention, bottom surface 420 of support layer 40 may comprise an adhesive surface. Alternatively, bottom surface 420 of support layer 40 may be otherwise associated with an adhesive (through, without limitation, fastening to an adhesive film, coating with an adhesive substance, etc.). In those specific embodiments wherein bottom surface 420 of support layer 40 is adhesive or otherwise associated with an adhesive, the adhesive may be used to mount electrical power supply system 50 upon various surfaces. Further, the adhesive may be of sufficient strength for permanent mounting, or it may be of a strength needed for temporary mounting. These specific embodiments allow electrical power supply system 50 to be mounted quite easily and provide a number of benefits. For example, these embodiments according to the present invention avoid the often necessary professional installation associated with traditional track power supply systems. Further, when mounted upon a surface, electrical power supply system 50 can be essentially flat, and thus quite straightforward to clean.

As discussed above, protective layer 10, first conductive material 20, second conductive material 30, and support layer 40 may be flexible or semi-flexible, which allows electrical power supply system 50 to be mounted upon surfaces that are flat, as well as those that are not. Specifically, if each of protective layer 10, first conductive material 20, second conductive material 30, and support layer 40 is flexible or semi-flexible, electrical power supply system 50 may be mounted in areas where it would have previously been difficult to mount a power supply, such as, without limitation, along a wall, counter-top, bar, beer tower or shelves with curves near a point-of-purchase display.

As shown in FIG. 2, electrical power supply system 50 may further comprise one or more connector device(s) 60, which are shown in more detail in FIG. 3. As shown in FIG. 3, connector device(s) 60 may comprise a first conductive contact 70 and a second conductive contact 80. In specific embodiments, first conductive contact 70 and second conductive contact 80 may comprise spring clips. In one specific embodiment, and as shown in FIG. 3, first conductive contact 70 is designed to engage first conductive material 20 and second conductive contact 80 is designed to engage second conductive material 30. Specifically, one of first conductive contact 70 and second conductive contact 80 may be positioned closer to distal surface 520 than the other, such that the conductive contacts 70, 80 are arranged in a staggered fashion. In specific embodiments, first conductive contact 70 may be connected to third conductive material 710 and second conductive contact 80 may be connected to fourth conductive material 810. These connections may be made by soldering, clamping, or any other method of connection as understood by one of ordinary skill in the art. In certain embodiments, connection to conductive materials 710 and 810 can occur through a circuit breaker/overcurrent protection device as described in more detail below. In additional embodiments, one single conductive material may comprise both first conductive contact 70 and third conductive material 710. Further, one single conductive material may comprise both second conductive contact 80 and fourth conductive material 810. In specific embodiments, third conductive material 710 and fourth conductive material 810 may extend from connector device 60 to an electrical device, thus acting as a conduit for electrical power to travel from said electrical power supply system 50 to an electrical device.

Each of third conductive material 710 and fourth conductive material 810 may comprise any conductive material as understood by one of ordinary skill in the art, and may specifically comprise any appropriate metal such as, without limitation, copper, silver, aluminum, steel, gold, tin, lead, nickel, or an alloy; any appropriate non-metallic conductor such as, without limitation, graphite; or any combination thereof. As shown, third conductive material 710 and fourth conductive material 810 may each comprise a round wire. Alternatively, third conductive material 710 and fourth conductive material 810 may each comprise a flat strip or any other appropriate shape. In specific embodiments, third conductive material 710 and fourth conductive material 810 may each comprise a flexible or semi-flexible material. Alternatively, third conductive material 710 and fourth conductive material 810 may each comprise a rigid or semi-rigid material.

As discussed above, in specific embodiments, first conductive material 20 may act as a powered lead and second conductive material 30 may act as a neutral lead. In such a situation, when first conductive contact 70 engages first conductive material 20, first conductive contact 70 and third conductive material 710 also become powered leads and second conductive contact 80 and fourth conductive material 810 become neutral leads. As such, electrical power can be routed through electrical power supply system 50 to an electrical device. Similarly, if first conductive material 20 was acting as a neutral lead and second conductive material 30 was acting as a powered lead, first conductive contact 70 and third conductive material 710 would become neutral leads and second conductive contact 80 and fourth conductive material 810 would become powered leads, thus also enabling electrical power to be routed through electrical power supply system 50 to an electrical device.

As will be understood by one of ordinary skill in the art, in specific embodiments, connector device 60 may further comprise an over-current protection circuit. In such specific embodiments, the over-protection circuit may monitor the current voltage draw of the electrical device that it is associated with, and may terminate operation of that connector device 60 if that voltage draw exceeds a preset voltage level. In such embodiments, connector device 60 may have one or more indicators, such as, in one non-limiting example, one or more light emitting diodes (LEDs) attached to it to indicate the operation status of that connector device 60. For example, if the connector device 60 is working, a green LED may be lit, and if the connector device 60's operation has been terminated by the over-current protection circuit, a red LED may be lit. In alternative embodiments, some other notification device may be used to indicate when the over-current protection circuit has terminated operation of a connector device 60. In specific embodiments, the over-current protection circuit may be automatically resetting. For example, once a given connector device 60's operation has been terminated by an over-current protection circuit, in certain embodiments that connector device 60's operation can be restored by disconnecting it from electrical power supply system 50 and then reconnecting it. Alternatively, the system can reset by eliminating the source of fault by, without limitation, replacing faulty portions of the system. Mechanisms to achieve these benefits are understood by those of ordinary skill in the art.

In specific embodiments, connector device 60 may be used as a conduit to route electrical power from a power source to electrical power supply system 50. In such specific embodiments, the power source may be, without limitation, a standard low voltage transformer, a standard DC power supply, or any other power source as understood by one of ordinary skill in the art.

In specific embodiments, electrical power supply system 50 may comprise one or more connector device(s) 60, each acting as a conduit to route electrical power from electrical power supply system 50 to an electrical device. In specific embodiments, electrical power supply system 50 may comprise two or more connector devices 60, with one connector device 60 acting as a conduit to route electrical power from a power source to electrical power supply system 50 and each of the other one or more connector devices 60 acting as a conduit to route electrical power from electrical power supply system 50 to an electrical device. Electrical devices that could be used in conjunction with the present invention include, for exemplary purposes only and not to limit the invention, point of purchase displays, lighted signs, noise generators, moving ornamentations, video monitors, computers, clocks, lamps, radios, speaker systems, smoke generators, fountains, wireless devices and circuits. Further, the present invention can be used to provide power to, without limitation, beer tap handles as described in U.S. Pat. No. 6,932,638 or co-pending U.S. patent application Ser. No. 11/637,164, each of which is hereby incorporated by reference.

It is foreseen that the present invention may be used in environments that are prone to liquid spills, debris buildup, and/or accidental contact (by a human or animal such as a pet). In specific embodiments, protective layer 10 serves to shield first conductive material 20 and second conductive material 30 from those liquid spills, debris buildup, and/or accidental contact. Of course, protective layer 10 may also serve to shield first conductive material 20 and second conductive material 30 from other unwanted contact such as dirt spills, contact with metals that may cause a short, and the like.

Further, in specific embodiments as discussed above, protective layer 10 and the junction of protective layer 10 and support layer 40 along distal end 520 acts in concert to also shield first conductive material 20 and second conductive material 30 from liquid spills, debris buildup, and/or accidental contact.

Although the present invention has been described in considerable detail with reference to certain specific embodiments, other embodiments and variations will be apparent to those of ordinary skill in the art. Therefore, the spirit and scope of the claims herein should not be limited to the description of the specific embodiments contained herein.

What is claimed is:

1. An electrical power supply system comprising:
a non-conductive protective layer comprising a top surface and a bottom surface;
a non-conductive support layer comprising a top surface and a bottom surface;
a first conductive material; and
a second conductive material,
wherein said first conductive material and said second conductive material are located between said top surface of said protective layer and said bottom surface of said support layer.

2. An electrical power supply system according to claim 1, wherein said non-conductive support layer is shaped to allow access to said first conductive material and said second conductive material.

3. An electrical power supply system according to claim 1, wherein said bottom surface of said support layer is adhesive or is associated with an adhesive.

4. An electrical power supply system according to claim 1, further comprising one or more connector devices, said connector devices comprising:
a first conductive contact; and
a second conductive contact,
wherein when engaged to said first and second conductive materials said first conductive contact can engage said first conductive material, said second conductive contact can engage said second conductive material; and
wherein said connector device provides a conduit for electrical power to travel from said electrical power supply to an electrical device.

5. An electrical power supply system according to claim 4, wherein one or more of said one or more connector devices further comprises an over-current protection circuit.

6. An electrical power supply system according to claim 5, wherein said one or more over-current protection circuits monitor the current voltage draw through said respective over-current protection circuit's connector device and wherein said one or more over-current protection circuits may terminate operation of said respective over-current protection circuit's connector device if said voltage draw of said connector device exceeds a preset voltage level.

7. An electrical power supply system according to claim 5, wherein said over-current protection circuit(s) are automatically resetting.

8. An electrical power supply system according to claim 1, wherein said electrical power supply system operates using about 50 volts or less.

9. An electrical power supply system according to claim 1, wherein said non-conductive protective layer, said first conductive material, and said second conductive material are created as a co-extrusion.

10. An electrical power supply system according to claim 1, wherein one or more of said protective layer, said first conductive material, said second conductive material, and said support layer are flexible.

11. An electrical power supply system according to claim 1, wherein said protective layer and/or said support layer comprise a non-conductive material selected from the group consisting of rubber, polyethylene, polyvinyl chloride, impregnated paper, neoprene, plastic, foam, glass, porcelain, composite, and combinations thereof.

12. An electrical power supply system according to claim 1, wherein said first conductive material and/or said second conductive material comprise a conductive material selected from the group consisting of copper, silver, aluminum, steel, gold, tin, lead, nickel, graphite, and combinations thereof.

13. An electrical power supply system according to claim 1 wherein said system is mounted to a surface and used to power one or more point of purchase displays.

14. An electrical power supply system according to claim 1 wherein said system is used to power an electrical device selected from the group consisting of a beer tap handle, a lighted sign, a noise generator, a moving ornamentation, a video monitor, a computer, a clock, a lamp, a radio, a speaker system, a smoke generator, a fountain, a wireless device and a circuit.

15. An over current protection circuit for use with a system according to claim 4.

16. A method for providing electrical power comprising:
providing a non-conductive protective layer comprising a top surface and a bottom surface;
providing a non-conductive support layer comprising a top surface and a bottom surface;
providing a first conductive material; and
providing a second conductive material,
wherein when engaged to said first and second conductive materials said first conductive material and said second conductive material are located between said top surface of said protective layer and said bottom surface of said support layer and wherein said non-conductive support layer is shaped to allow access to said first conductive material and said second conductive material and
wherein said electrical power system further comprises one or more connector devices, said connector device comprising:
a first conductive contact; and
a second conductive contact,
wherein said first conductive contact is designed to engage said first conductive material, said second conductive contact is designed to engage said second conductive material; and
wherein said connector device provides a conduit for electrical power to travel from said electrical power supply to an electrical device.

17. A method according to claim 16, wherein said bottom surface of said support layer is adhesive or is associated with an adhesive for mounting onto a surface.

18. A method according to claim 16, wherein one or more of said protective layer, said first conductive material, said second conductive material, and said support layer are flexible.

19. An electrical power supply system comprising:
a non-conductive protective layer comprising a top surface and a bottom surface;
a non-conductive support layer comprising a top surface and a bottom surface;
a first conductive material; and
a second conductive material,
wherein said first conductive material and said second conductive material are located between said top surface of said protective layer and said bottom surface of said support layer;
wherein said non-conductive support layer is shaped to allow access to said first conductive material and said second conductive material;
wherein said bottom surface of said support layer is adhesive or is associated with an adhesive;
wherein one or more of said protective layer, said first conductive material, said second conductive material, and said support layer are flexible.

20. An electrical power supply system according to claim 19, wherein said electrical power system operates using a voltage of about 50 volts or less and powers an electrical device in a point of purchase display.

21. A connector device for use with an electrical power supply system wherein said electrical power system comprises:
a non-conductive protective layer comprising a top surface and a bottom surface;
a non-conductive support layer comprising a top surface and a bottom surface;
a first conductive material; and
a second conductive material,
wherein said first conductive material and said second conductive material are located between said top surface of said protective layer and said bottom surface of said support layer and wherein said connector device comprises
a first conductive contact; and
a second conductive contact,
wherein when engaged to said first and second conductive materials said first conductive contact can engage said first conductive material, said second conductive contact can engage said second conductive material; and
wherein said connector device provides a conduit for electrical power to travel from said electrical power supply to an electrical device.

22. A connector device according to claim 21 wherein said connector device comprises an over-current protection circuit.

23. A connector device according to claim 22 wherein said over-current protection circuit monitors the current voltage draw through said connector device and wherein said over-current protection circuit may terminate operation of said connector device if said voltage draw of said connector device exceeds a preset voltage level.

24. A connector device according to claim 22 wherein said over-current protection circuit is automatically resetting.
